(19) United States
(12) Patent Application Publication
(10) Pub. No.: US 2018/0188128 A1
(43) Pub. Date: Jul. 5, 2018

(54) METHOD FOR CALIBRATING A TORQUE SENSOR ARRANGED IN THE DRIVETRAIN OF A MOTOR VEHICLE

(71) Applicant: CONTINENTAL AUTOMOTIVE GMBH, Hannover (DE)

(72) Inventors: Philippe Grass, Regensburg (DE); Hong Zhang, Tegernheim (DE)

(73) Assignee: CONTINENTAL AUTOMOTIVE GMBH, Hannover (DE)

(21) Appl. No.: 15/905,084

(22) Filed: Feb. 26, 2018

Related U.S. Application Data
(63) Continuation of application No. PCT/EP2016/057454, filed on Apr. 5, 2016.

(30) Foreign Application Priority Data
Aug. 26, 2015 (DE) 10 2015 216 339.3

(51) Int. Cl. G01L 25/00; B60R 16/023; B60L 3/12

(52) U.S. Cl. CPC G01L 25/003; B60L 3/12; B60R 16/0231

(57) ABSTRACT

The invention relates to a method for calibrating a torque sensor which is arranged in the drivetrain of a motor vehicle. In order to specify a method for calibrating a torque sensor which is arranged in the drivetrain of a motor vehicle, which method is less complex and therefore more cost-effective, firstly the uncalibrated torque sensor is arranged in the fully completed drivetrain in the motor vehicle and subsequently a first known value for a torque is applied to the drivetrain of the motor vehicle and then a second known value for a torque is applied to the drivetrain of the motor vehicle and the first output signal which is generated by the torque sensor is assigned to the first known value for a torque and the second output signal which is generated by the torque sensor is assigned to the second known value for a torque, the torque sensor being calibrated in the fully completed drivetrain of the motor vehicle in this way.

### CROSS-REFERENCE TO RELATED APPLICATIONS

This application claims the benefit of PCT Application PCT/DE2016/057454, filed Apr. 5, 2016, which claims priority to German Patent Application 10 2015 216 339.3, filed Aug. 26, 2015. The disclosures of the above applications are incorporated herein by reference.

### FIELD OF THE INVENTION

The invention relates to a method for calibrating a torque sensor which is arranged in the drivetrain of a motor vehicle.

### BACKGROUND OF THE INVENTION

A torque sensor of this kind is known from DE 10 2006 044 779 B4. This document discloses an apparatus for detecting a torque using an elastic element which may be deformed by the torque. The elastic element surrounds an internal region and a sensor which is intended to detect a deformation of the element, which deformation is generated by the torque, so as to form electrical signals, wherein the sensor is arranged in the internal region of the elastic element and the elastic element has at least one electrically conductive structure which at least partially shields the sensor from electric fields from the region around the elastic element.

Torque sensors are used in the drivetrain of motor vehicles in order to measure, for example, the torque which is transmitted to the drive wheels by the drive motor.

The vector of the torque is given as the cross product of the distance vector with the force vector. In this case, the distance vector is formed by the reference point of the torque in relation to the point of application of the force. The direction of the torque vector indicates both the direction of the rotation axis and also the rotation sense of the torque. When all of the forces and distance vectors lie in a plane orthogonal in relation to the rotation axis, the consideration is simplified since the torque may then be treated as a scalar amount. In this case, the indication of the direction is reduced to the mathematical sign of the torque. In accordance with the general vectorial definition, torques which act in the counterclockwise direction in a plan view of the plane are considered to be positive, and torques in the clockwise direction are accordingly considered to be negative. This two-dimensional special case is the general case for a large number of technical applications in which the position of the rotation axis is prespecified by the bearings. The torque which is measured on the shaft of a motor vehicle or on the output shaft of a transmission is also called the drive torque. The torque which may drive a prime mover out of a stationary state or which is required by a drive machine or a vehicle when starting up is also called the start-up torque.

Within the meaning of this patent application, motor vehicles are considered to be all motor vehicles which transmit a force to at least one drive wheel from a drive motor by means of a drivetrain. These motor vehicles include, for example, passenger cars, motorcycles, heavy goods vehicles, construction machines and also rail vehicles.

Torque sensors in the drivetrain of a motor vehicle have to be calibrated before they are first used, in order to be able to assign a value for the torque which is applied in the drivetrain to the output signal which is generated by the torque sensor. According to the prior art, this calibration involves the drive shaft and the torque sensor, as one assembly, being transferred to a calibration system and being calibrated in the calibration system before being installed in the motor vehicle. Following this, the assembly comprising the drive shaft and the torque sensor is installed in the motor vehicle. This has the disadvantage that a very large and heavy assembly has to be calibrated in a correspondingly large calibration system. Furthermore, in the event of repair of a defective torque sensor, the entire assembly which consists of the drive shaft and the torque sensor has to be disassembled and recalibrated. This is complex and expensive.

### SUMMARY OF THE INVENTION

The invention is therefore based on the object of specifying a method for calibrating a torque sensor which is arranged in the drivetrain of a motor vehicle, which method is less complex and therefore more cost-effective than the method known from the prior art for calibrating a torque sensor which is arranged in the drivetrain of a motor vehicle.

According to the invention, the object is achieved by the features described. Since firstly the uncalibrated torque sensor is arranged in the fully completed drivetrain in the motor vehicle and subsequently a first known value for a torque is applied to the drivetrain of the motor vehicle and then a second known value for a torque is applied to the drivetrain of the motor vehicle and the first output signal which is generated by the torque sensor is assigned to the first known value for a torque and the second output signal which is generated by the torque sensor is assigned to the second known value for a torque, the torque sensor being calibrated in the fully completed drivetrain of the motor vehicle in this way, complex and expensive calibration of the assembly, which comprises the drive shaft and the torque sensor, in a separate measurement system may be dispensed with. In accordance with the method according to the invention, the uncalibrated torque sensor is installed in the motor vehicle and calibrated in the installed state, the vehicle itself forming a constituent part of the measurement system which is required for calibration in this way.

In one refinement of the invention, the first known value for a torque which is applied to the drivetrain of the motor vehicle corresponds to a zero torque. Since no torque is applied to the drive shaft in this situation, the torque value zero is assigned to the corresponding measurement value of the torque sensor.

According to an advantageous development, the second known value for a torque which is applied to the drivetrain of the motor vehicle corresponds to a maximum torque. A second measurement point which is assigned to the corresponding measurement value of the torque sensor is provided with the maximum torque.

In a next development, the zero torque is generated by opening a clutch and/or engaging neutral in a transmission. This is a very simple procedure in order to calibrate the torque sensor to the zero point.

Furthermore, it is advantageous when the maximum torque is generated by driving under full load or simulating driving under full load. As a result, a second value for calibrating the torque sensor is provided in a very simple manner.

In one development, the first known value for a torque and/or the second known value for a torque are/is applied to the drivetrain of the motor vehicle by a machine which is arranged outside the motor vehicle. This machine which is arranged outside the motor vehicle is such that it generates precisely defined torques and makes these items of information available to the measurement station for further processing.

As an alternative to this, the first known value for a torque and/or the second known value for a torque is applied to the drivetrain of the motor vehicle by a machine which is arranged inside the motor vehicle. Machines which are arranged inside the motor vehicle and the development of torque of which is already known at least in specific operating situations may be used here. These items of information may also be made available to the measurement station for further processing. A machine of this kind which is arranged inside the motor vehicle could be, for example, an internal combustion engine, the characteristic map of which is correlated with the values for a generated torque. Furthermore, it would be feasible to use an electric motor of the motor vehicle in order to apply a predefined torque to the drive shaft.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The invention permits numerous refinements. Some of the refinements are intended to be explained with reference to the figures illustrated in the drawings, in which:

FIG. 1 shows a measurement bridge circuit for identifying torque in a motor vehicle;

FIG. 2 shows a torque sensor comprising an elastic element; and

FIG. 3 shows a factory in which a motor vehicle is located.

### DETAILED DESCRIPTION OF THE PREFERRED EMBODIMENTS

The following description of the preferred embodiment(s) is merely exemplary in nature and is in no way intended to limit the invention, its application, or uses.

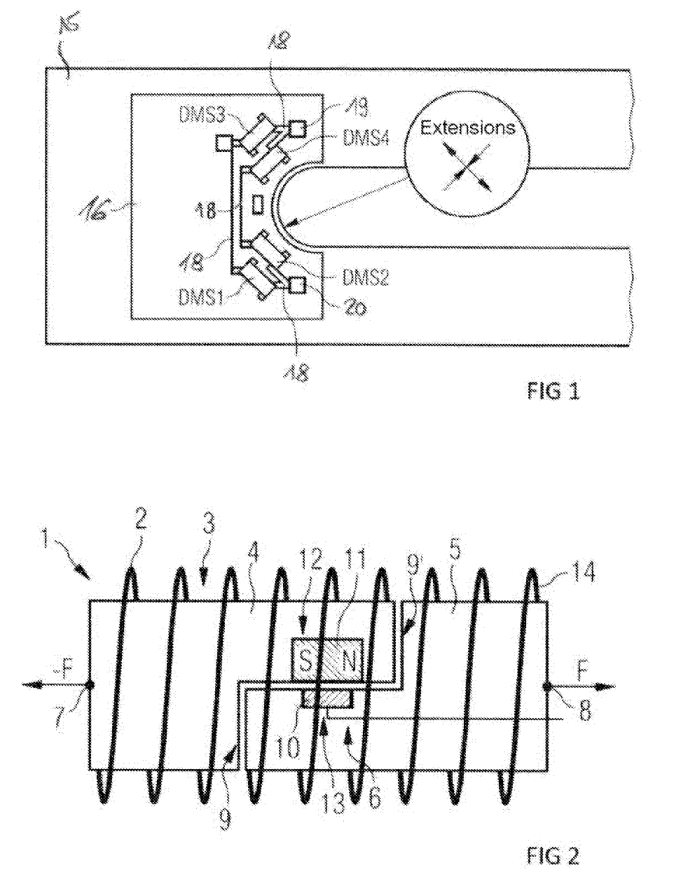

FIG. 1 illustrates a measurement bridge circuit for identifying torque as is used in a motor vehicle 21. An insulating layer 16 is arranged on a carrier shaft 15 which is to be subjected to torsion. A resistance measurement bridge which consists of extension-sensitive measurement resistors DMS1 to DMS4 is applied to the insulating layer 16 using thick-film technology. The measurement resistors DMS1 to DMS4 are electrically interconnected by conductor tracks 18 to form the measurement bridge. Measurement points 19, 20 are provided in order to tap off the electrical signals which develop in the form of potential differences in the event of extension of the measurement resistors DMS1 to DMS4. As an alternative, the signals are also supplied directly to an electronic evaluation circuit, not illustrated any further here, which is arranged on the thick-film insulator 16, by means of further conductor tracks. A continuous recess is made in the metal carrier shaft 1 in order to obtain the maximum surface area extension in the measurement resistors DMS1 to DMS4. A recess in the form of an elongate hole is illustrated in this case, but recesses of other shapes may also be advantageously used. A measurement bridge circuit of this kind may be used to measure a torque in the drivetrain of a motor vehicle 21.

FIG. 2 shows a torque sensor 1 comprising an elastic element 2, which surrounds an inner region 3, and a two-part sensor 6, which is held on holders 4 and 5, for detecting a deformation in the elastic element 2, which deformation is produced by the force, and therefore the torque which is applied to the apparatus 1 so as to form electrical signals. The sensor element 6 is arranged in the inner region 3 of the elastic element 2.

In this exemplary embodiment, the elastic element 2 is a helical spring which is composed of soft-magnetic, electrically conductive spring steel. The thread pitch of the helical spring is selected such that the spring has, unlike that illustrated in the schematic drawing, as large a number of turns as possible. The spring constant is selected depending on the maximum value of the torque which is to be detected such that a pre-specified elastic change in length of the helical spring does not exceed a pre-specified maximum value when the maximum force is applied.

The interior space 3 which is surrounded by the elastic element 2 contains the two holders 4 and 5 which have, firstly, coupling points 7 and 8 to which external elements for transmitting force are coupled. Secondly, each of the holders 4 and 5 is connected to another end of the elastic element 2 as the point of application, so that a relative movement of the holders 4 and 5 along the screw axis of the elastic element leads to deformation, here precise compression or extension of the elastic element 2, with a preferably linear dependence on the force. Therefore, the holders also serve as coupling elements.

To this end, the holders 4 and 5 which have a cylindrical basic shape are guided along the screw axis in a linear manner by a guide, not shown, for example a rod which runs coaxially to the screw axis through a corresponding guide hole in the holders 4 and 5.

The sensor element 6 is designed in the form of a two-part sensor element which operates in a contactless manner and includes a Hall sensor element 10 as the magnetic field sensor and a permanent magnet 11 as the second part. The Hall sensor element 10 and the magnet 11 are arranged in receptacles 12 and 13 in the holder 4 and, respectively, 5 in the surfaces, which run parallel in relation to one another, of the ends of the holders 4 and, respectively, 5 in the region of the recesses 9, 9′ such that the dipole of the magnet 11 runs parallel in relation to the direction of the relative movement of the holders 4 and 5 and, respectively, of the screw axis of the elastic element 2 and a movement of the magnet 11 relative to the Hall sensor element 10 may be detected by the dipole.

In this exemplary embodiment, the Hall sensor element 10 already has an evaluation device which processes and amplifies the signals from the Hall sensor element 10. Signals from the sensor element 6 may be detected via a signal line which is guided in the holder 4.

When a force or a torque is applied between the holders 4 and 5, the holders move relative to one another with deformation of the elastic element 2, the helical spring. The extent of the movement is determined by the elastic properties of the elastic element 2. The movement, which corresponds to the force or to the torque, is detected by the sensor element 6 which then outputs corresponding detection signals which are a measure of the torque acting on the apparatus.

The torque sensors 1 illustrated here in FIGS. 1 and 2 have to be calibrated before they are first employed in the motor vehicle, in order to be able to deliver usable items of information about the torque present in the drivetrain.

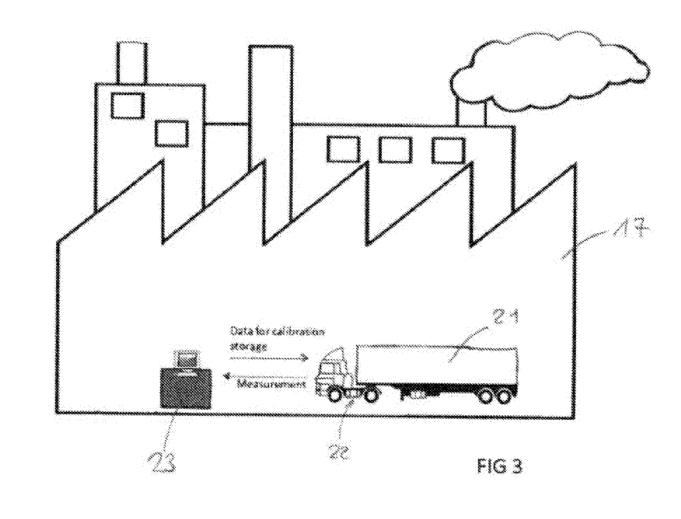

FIG. 3 shows a factory 17 in which a motor vehicle 21, which is illustrated as a heavy goods vehicle here, is located. The method for calibrating a torque sensor 1 which is arranged in the drivetrain 22 of the motor vehicle 21 is carried out in the factory 17. To this end, a measurement station 23 is arranged in the factory 17, the measurement station gathering the measurement data from the torque sensor on the one hand and at least the first known value for a torque, which is applied to the drivetrain 22 of the motor vehicle 21, and a second known value for a torque, which is applied to the drivetrain 22 of the motor vehicle 21. The initially uncalibrated torque sensor, which is arranged in the fully completed drivetrain 22 of the motor vehicle 21, is calibrated by way of the measurement station 23. To this end, a first known value for a torque is applied to the drivetrain 22 of the motor vehicle 21 and a second known value for a torque is applied to the drivetrain 22 of the motor vehicle 21 and subsequently the first output signal which is generated by the torque sensor 1 is assigned to the first known value for a torque and the second output signal which is generated by the torque sensor 1 is assigned to the second known value for a torque, wherein the torque sensor is calibrated in the fully completed drivetrain 22 of the motor vehicle 21. This method substantially simplifies the calibration of torque sensors in motor vehicles since it is no longer necessary for the complete unit, which is composed of the drivetrain and the torque sensor, to be calibrated outside the vehicle, but rather the entire motor vehicle 21 is fully involved in the calibration process. Here, it is feasible, for example, that the first known value for a torque which is applied to the drivetrain 22 of the motor vehicle 21 is a zero torque. In this context, zero torque means that no torque is applied to the drive shaft, the torque of which is intended to be observed. This is achieved, for example, by the clutch between the drive motor and the drive wheels being open, or the neutral gear having been engaged in the transmission.

Furthermore, a maximum torque may be applied to the drivetrain 22 of the motor vehicle 21 in the factory 17 by, for example, driving of the motor vehicle 21 under full load being simulated. It is also feasible that a machine which is arranged outside the motor vehicle 21 in the production hall 17 applies a precisely defined torque value to the drivetrain 22 of the motor vehicle 21 and sends the precisely defined torque value to the measurement station 23, in response to which the measurement station 23 performs calibration of the torque sensor 1 in the fully completed drivetrain 22 within the motor vehicle 21 using the measured values from the torque sensor 1. Machines which are arranged within the motor vehicle 21 may also apply the first and the second known value for a torque to the drivetrain of the motor vehicle 21. In this case, it is feasible that the internal combustion engine of the motor vehicle 21 is used in order to apply defined torques to the drivetrain. It is also feasible to correlate the characteristic map of the internal combustion engine of the motor vehicle 21 with the measurement values of the torque sensor and therefore calibrate the torque sensor. Furthermore, it is feasible that an electric motor which is arranged in the motor vehicle 21 applies a first and a second known measurement value for a torque to the drivetrain 22. The torque sensor in the drivetrain of the motor vehicle may also be calibrated in this way.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for calibrating a torque sensor, comprising the steps of:
providing a torque sensor;
providing a first known value for a torque;
providing a second known value for a torque;
providing a first output signal;
providing a second output signal;
arranging the uncalibrated torque sensor in the fully completed drivetrain in the motor vehicle;
applying the first known value for a torque to the drivetrain of the motor vehicle;
applying the second known value for a torque to the drivetrain of the motor vehicle;
generating the first output signal using the torque sensor;
assigning the first output signal to the first known value for a torque;
generating the second output signal using the torque sensor;
assigning the second output signal to the second known value for a torque.

2. The method for calibrating a torque sensor of claim 1, further comprising the steps of:
providing a zero torque; and
providing the first known value for a torque to correspond to the zero torque;
applying the first known valve to the drivetrain of the motor vehicle.

3. The method for calibrating a torque sensor of claim 2, further comprising the steps of:
providing a clutch;
generating the zero torque by opening the clutch.

4. The method for calibrating a torque sensor of claim 2, further comprising the steps of:
providing a transmission;
generating the zero torque is generated by engaging neutral in the transmission.

5. The method for calibrating a torque sensor of claim 1, further comprising the steps of:
providing a maximum torque; and
providing the second known value for a torque to correspond to the maximum torque;
applying the maximum torque to the drivetrain of the motor vehicle.

6. The method for calibrating a torque sensor of claim 5, further comprising the steps of generating the maximum torque by driving under full load.

7. The method for calibrating a torque sensor of claim 5, further comprising the steps of generating the maximum torque by simulating driving under full load.

8. The method for calibrating a torque sensor of claim 1, further comprising the steps of:
providing a machine arranged outside of the motor vehicle;
applying the first known value for a torque to the drivetrain of the motor vehicle using the machine arranged outside of the motor vehicle;
applying the second known value for a torque to the drivetrain of the motor vehicle using the machine arranged outside of the motor vehicle.

9. The method for calibrating a torque sensor of claim 1, further comprising the steps of:
providing a machine arranged within the motor vehicle;
applying the first known value for a torque to the drivetrain of the motor vehicle using the machine arranged within the motor vehicle;
applying the second known value for a torque to the drivetrain of the motor vehicle using the machine arranged within the motor vehicle.

10. The method for calibrating a torque sensor of claim 9, further comprising the steps of providing the machine arranged within the motor vehicle to be an internal combustion engine of the motor vehicle.

11. The method for calibrating a torque sensor of claim 10, further comprising the steps of:
providing a characteristic map, the characteristic map representing a plurality of operatin characteristics of the internal combustion engine;
correlating the characteristic map of the internal combustion engine with the signals which are generated by the torque sensor.

12. The method for calibrating a torque sensor of claim 9, further comprising the steps of providing the machine which is arranged within the motor vehicle to be an electric motor of the motor vehicle.

13. The method for calibrating a torque sensor of claim 12, further comprising the steps of:
providing a characteristic map, the characteristic map representing a plurality of operatin characteristics of the electric motor;
correlating the characteristic map of the electric motor is correlated with the signals which are generated by the torque sensor.
